(19) United States
(12) Patent Application Publication
(10) Pub. No.: US 2020/0158967 A1
(43) Pub. Date: May 21, 2020

(54) OPTICAL FIBER CONNECTOR COUPLING AND PACKAGE FOR OPTICALLY INTERCONNECTED CHIPS

(71) Applicant: Nokia Solutions and Networks Oy, Espoo (FI)

(72) Inventors: Peter Winzer, Aberdeen, NJ (US); David Neilson, Old Bridge, NJ (US); Shahriar Shahramian, Chatham, NJ (US)

(21) Appl. No.: 16/688,436

(22) Filed: Nov. 19, 2019

Related U.S. Application Data
(60) Provisional application No. 62/770,666, filed on Nov. 21, 2018.
(60) Provisional application No. 62/770,331, filed on Nov. 21, 2018.

(51) Int. Cl. G02B 6/42

(52) U.S. Cl. CPC G02B 6/4233; G02B 6/4274; G02B 6/4214; G02B 6/4243

(57) ABSTRACT

An apparatus including an optical fiber connector module and an integrated optical device. The optical fiber connection module including an array of holes there-through for holding end segments of optical fibers therein such that the end of each of the optical fibers has a fixed distance relationship with an external surface of the module, the module having one or more electrical conductor lines therein with electrical contacts thereto along the external surface and having one or more first mechanical alignment structures along the external surface. The integrated optical device having one or more second mechanical alignment structures along an outer surface thereof, the first and second mechanical alignment structures capable of being fitted together such that the outer surface and external surface have a fixed relative positional relationship and such that the electrical contacts of the optical fiber connector module are adjacent to electrical contacts of the integrated optical device.

### CROSS-REFERENCE TO RELATED APPLICATION

This application claims the benefit of U.S. Provisional Application Ser. No. 62/770,666, filed by Peter Winzer, et al. on Nov. 21, 2018, entitled “OPTICAL FIBER CONNECTOR COUPLING AND PACKAGE FOR OPTICALLY INTERCONNECTED CHIPS,” which was filed concurrently with U.S. Provisional Application Ser. No. 62/770,331, by Peter Winzer, et al. on Nov. 21, 2018, entitled “CHIP-TO-CHIP OPTICAL INTERCONNECT,” commonly assigned with this application and incorporated herein by reference in its entirety.

### TECHNICAL FIELD

This application is directed, in general, to optical devices and, more specifically, to optical devices configured to be coupled via optical fibers.

### BACKGROUND

This section introduces aspects that may help facilitate a better understanding of the inventions. Accordingly, the statements of this section are to be read in this light and are not to be understood as admissions about what is prior art or what is not prior art.

Optical fibers are sometimes individually coupled to vertical optical couplers of optical chips (e.g., photonic integrated circuits) by using mechanical clips or other mechanical connection devices that apply a mechanical structure fixing the end of the optical fiber with respect to the optical chip. However, finding the optimal alignment of the end of the optical fiber with respect to the optical chip can be tedious and difficult to achieve, and, the mechanical coupling device may use forces that can damage the chip or the optical fiber or negatively change the alignment.

Often high speed (e.g., ≥1 Gb/s, ≥5 Gb/s,) communication in electrical chips relies on solder electrical connections to provide low inductance distortion-free signals. The use of soldered electrical connections, however, can make it difficult to replace electrical or optical chips, e.g. because the solder reflow process has to be done in a manner that retains a high quality electrical connection to support high speed communications.

### SUMMARY

One embodiment is an apparatus including an optical fiber connector module and an integrated optical device. The optical fiber connection module can include an array of holes there-through for holding end segments of optical fibers therein such that the end of each of the optical fibers has a fixed distance relationship with an external surface of the module, the module having one or more electrical conductor lines therein with electrical contacts thereto along the external surface and having one or more first mechanical alignment structures along the external surface. The integrated optical device can have one or more second mechanical alignment structures along an outer surface thereof, the first and second mechanical alignment structures capable of being fitted together such that the outer surface and external surface have a fixed relative positional relationship and such that the electrical contacts of the optical fiber connector module are adjacent to electrical contacts of the integrated optical device.

Some embodiments further include an electrical monitoring circuit configured to monitor a relative distance between the surfaces based on one or more electrical signals applied to the contacts of the integrated optical device.

In some embodiments, the integrated optical device has an array of vertical optical couplers along the outer surface. In some such embodiments, the vertical optical couplers can be located to face adjacent ends of the optical fibers in response to the first and second mechanical alignment structures capable of being fitted together such that the outer surface and external surface have the fixed relative positional relationship.

Some embodiments further include the optical fibers, the optical fibers being multi-core optical fibers. In some such embodiments, the holes can be configured to enable rotation of the ends of the optical fibers around axes of the corresponding end segments.

In some embodiments, the mechanical alignment structure can be one of an opening or protrusion and the corresponding alignment structure can be the other of the protrusion or the opening.

In some embodiments, the alignment structure can be a side of the module and the corresponding alignment structure can be a socket configured to fit at least a portion of the side therein.

In some embodiments, the optical fiber connector module can be part of a multi-chip device package having an optical chip and an electrical chip.

Some embodiments further include a multi-chip device package including the integrated optical device and an electronics chip. The electronics chip can have solderless electrical connections configured to have power supply connections and the integrated optical device can be configured to optically provide data communications with respect to the electrical chip. In some such embodiments, the optical chip can be stacked on the electronics chip and the electronics chip can be fitted into a socket module having corresponding solderless electrical connections configured to contact the solderless electrical connections of the electronics chip. In some such embodiments, the socket module includes a mechanical alignment socket which can be configured to fit at least a portion of the electrical chip therein such that the solderless electrical connections of the electrical chip contact the corresponding solderless electrical connections of the socket module. In some such embodiments, some of the solderless electrical connections can be configured as a zero insertion force socket, zero land grid array socket or a ball grid array socket of the socket module.

### BRIEF DESCRIPTION OF DRAWINGS

The embodiments of the disclosure are best understood from the following detailed description, when read with the accompanying FIGUREs. Some features in the figures may be described as, for example, “top,” “bottom,” “vertical” or “lateral” for convenience in referring to those features. Such descriptions do not limit the orientation of such features with respect to the natural horizon or gravity. Various features may not be drawn to scale and may be arbitrarily increased or reduced in size for clarity of discussion. Reference is now made to the following descriptions taken in conjunction with the accompanying drawings, in which:

FIG. 1A presents a perspective view of one embodiment of an optical fiber connector module of an apparatus of the disclosure;

FIG. 1B presents a plan view of a bottom side of the module shown in FIG. 1A;

FIG. 2 presents a perspective view of another embodiment of an optical fiber connector module of the disclosure;

FIG. 3 presents a perspective view of another embodiment of an optical fiber connector module of the disclosure;

FIG. 4 presents an exploded perspective view of portions of a multi-chip device package embodiment of the apparatus;

FIG. 5 presents a cross-sectional view of another multi-chip device package embodiment of the apparatus;

In the Figures and text, similar or like reference symbols indicate elements with similar or the same functions and/or structures.

In the Figures, the relative dimensions of some features may be exaggerated to more clearly illustrate one or more of the structures or features therein.

Herein, various embodiments are described more fully by the Figures and the Detailed Description. Nevertheless, the inventions may be embodied in various forms and are not limited to the embodiments described in the Figures and Detailed Description of Illustrative Embodiments.

### DETAILED DESCRIPTION

The description and drawings merely illustrate the principles of the inventions. It will thus be appreciated that those skilled in the art will be able to devise various arrangements that, although not explicitly described or shown herein, embody the principles of the inventions and are included within its scope. Furthermore, all examples recited herein are principally intended expressly to be for pedagogical purposes to aid the reader in understanding the principles of the inventions and concepts contributed by the inventor(s) to furthering the art, and are to be construed as being without limitation to such specifically recited examples and conditions. Moreover, all statements herein reciting principles, aspects, and embodiments of the inventions, as well as specific examples thereof, are intended to encompass equivalents thereof. Additionally, the term, “or,” as used herein, refers to a non-exclusive or, unless otherwise indicated. Also, the various embodiments described herein are not necessarily mutually exclusive, as some embodiments can be combined with one or more other embodiments to form new embodiments.

Some embodiments of the disclosure benefit from our recognition that the coupling between optical fibers and optical chips can be facilitated by using an optical fiber connector module having mechanical alignment structures and/or electrical contacts to confirm the vertical and lateral alignment. The optical coupling can thereby be more reliably achieved using optically passive alignment and potential damaging mechanical forces to connect the optical fibers to the optical chips may be avoided. This is in contrast to some alignment procedures using active optical alignment, where light transfer across the connection is being monitored and maximized while the connection is being made. The optically passive alignment disclosed herein can be combined with electrical feedback (e.g., electrically active feedback) e.g., to confirm connection. In some embodiments, the optically passive alignment can be combined with other optically active alignment procedures to improve optical alignment (e.g., optical fibers rotated so that individual fiber cores can be better alignment with core interfaces in multiple core fiber embodiments).

Some embodiments of the disclosure benefits from our recognition that solderless electrical connections can be sufficient for DC power and low-speed (<1 Giga-bit/second (Gb/s)) control connections, with all high speed connections being handled by optical communication signals between an electrical chip and an optical chip of a multi-chip device package (e.g., optics-electronic device packages). Replacing high-speed electrical input-output communications with high-speed optical input-output communications enables the use of solderless connections, such as about zero insertion force (ZIF) type socket connections, to handle low-speed tasks. The use of such socket connections may allow chips to be easily replaced, e.g., due to a failure or during an upgrade and may remove a need for the chips and optical components to undergo potentially damaging solder reflow temperatures.

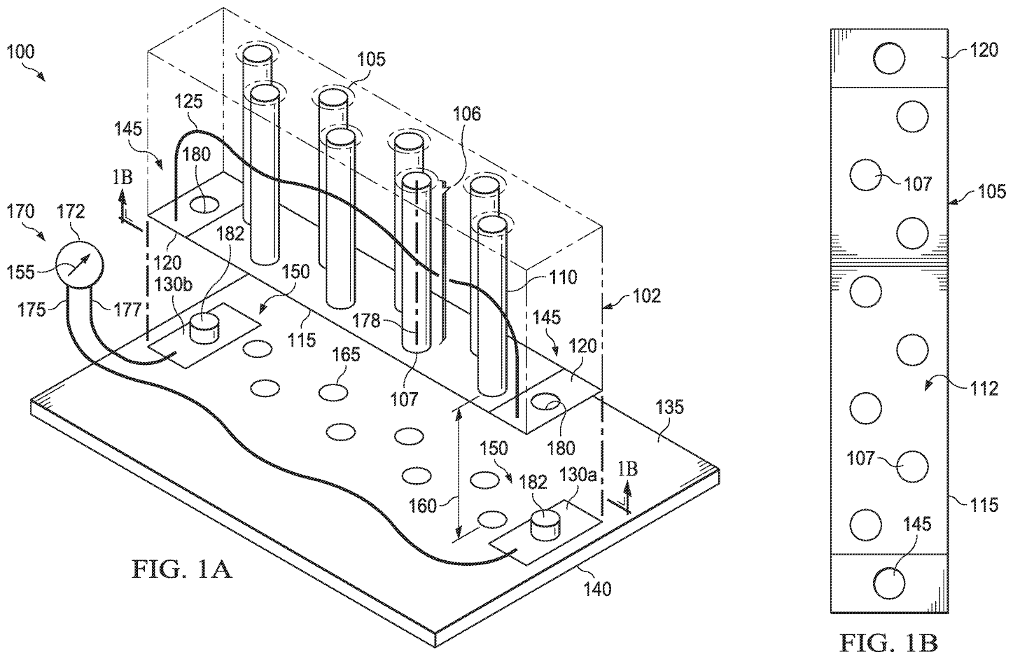

FIG. 1A presents a perspective view of one embodiment of apparatus including an optical fiber connector module and FIG. 1B presents a plan view (e.g., view line 1B-1B in FIG. 1A) of a bottom side of the module shown in FIG. 1A.

With continuing reference to FIGS. 1A and 1B throughout, embodiments of the apparatus 100 can include an optical fiber connector module 102 (e.g., a housing) configured to hold the ends of one or more optical fibers. E.g. the module 102 can include an array of holes (e.g., holes 105) there-through for holding end segments 106 of optical fibers therein such that the end 107 of each of the optical fibers 110 has a fixed distance relationship with an external surface of the module (e.g., outer surface 112 of bottom side 115 of the module 102). A portion (e.g., segment 106) of the end of each of the optical fibers 110 can be, e.g., essentially co-planar with an outer surface of the module 102 (e.g., outer surface 112 of bottom side 115). The apparatus 100 can also include a set of electrical contacts 120 located on different locations (e.g., separate locations) of the outer surface 112 of the optical fiber connector module 102. The set of electrical contacts 120 can be electrically coupled to each other by one or more electrically conductive lines (e.g., line 125 in the module 102). The set of electrical contacts 120 can be configured to make contact with or close to a second set of electrical contacts 130 located on a surface 135 of an integrated optical device 140 (e.g., an optical chip). The apparatus 100 can also include a mechanical alignment structure 145 located on or near the outer surface 112 of the module 102, the mechanical alignment structure 145 configured to fit with a corresponding mechanical alignment structure 150 (e.g., one or more second mechanical structures) located on or along a top surface (e.g., surface 135) of the integrated optical device 140.

The mechanical alignment structure 145 and the corresponding mechanical alignment structure 150, when fitted together, e.g., as male- and female complementary shapes, can place the set of electrical contacts 120 and the second set of electrical contacts 130 in close enough proximity to cause an electrical signal 155 from a first one of the electrical contacts of the second set of electrical contacts (e.g., contact 130a) and a second one of the electrical contacts of the second set of electrical contacts (e.g., contact 130b), e.g., due to actual contact connections or near contact connections, which generate detectable capacitances.

The electrical signal 155 can be configured to change as a function of the distance 160 between the ends 107 of the one or more optical fibers 110 and corresponding optical couplers 165 (e.g., vertical couplers) located on the surface 135 of the optical chip 140. E.g., the electrical signal 155 can reflect a measureable electrical connection or a measurable capacitance, as a non-mechanical indication for making a fiber connection.

The set of electrical contacts 120, conductive lines 125 and the second set of electrical contacts 130 can be part of an electrical monitoring circuit 170 of the apparatus 100, the circuit 170 further including an electrical sensor 172 connected to measure the electrical signal 155. For instance, electrically conductive lines 175, 177 (e.g., copper wire or other electrically conductive material) can be coupled to the second set of electrical contacts 130 and to the sensor 172 to complete to circuit.

The electrical signal 155 can be configured to have a target value when the ends 107 of the one or more optical fibers 110 are located above the corresponding optical couplers 165 of the integrated optical device 140 such that light transmission between the optical fibers 110 and, e.g., the vertical optical couplers 165 is maximized. The light can be in any of the common optical telecommunication wavelength band such as the Original, Short, Conventional, Long or Ultralong.

The physical contact and alignment between the apparatus 100 and the chip 140 can be monitored via the electrical monitoring circuit 170 by measuring the electrical signal 155 (e.g., current flow, resistance, potential difference, capacitance) across the one or more thin-film electrodes. Once physical contact is indicated through the electrical monitoring circuit 170 and the target value of the electrical signal 170 is reached, permanent (glue) or semi-permanent reversible (e.g., snap-on) mechanical fixation can be applied to secure the apparatus 100 and the chip 140 together without exerting excessive mechanical pressure, e.g., on the end segments 107 of the optical fibers 110.

In some embodiment, the electrical contacts of the set of electrical contacts 120 and the second set of electrical contacts 130 can be configured as metallic plates that are can be coplanar or about coplanar with the outer surface 112 of the module 102 and the surface 135 of the integrated optical device 140, respectively, and when fitted to together, the surfaces 112 135 can be coplanar with each other. In some embodiment, the electrical contacts 130 can be plated layers such as thin-film electrodes deposited on the side 115 of the apparatus 100 that is configured to mate with one of a plurality of thin-film electrodes deposited on the chip 140.

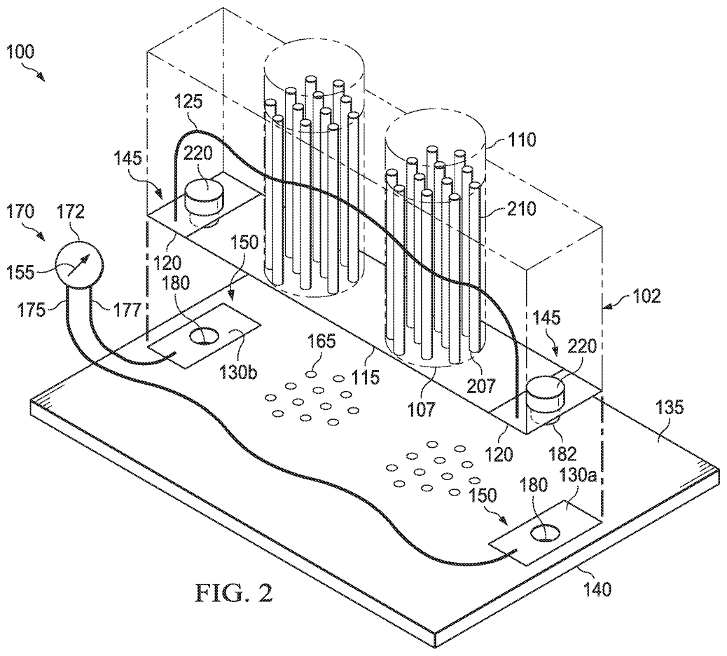

FIG. 2 presents a perspective view of another embodiment of the module 102 of the apparatus 100 of the disclosure. As illustrated, in some embodiments, the fibers 110 can be configured as single mode, multimode, and/or multicore optical fibers, e.g., having 4, 8, 12, etc. optical cores 210 per fiber 110. Each of the ends 207 of the cores 210 can be coplanar with each other and with the end 107 of the fiber 110. The cores 210 can be arranged in a pattern (e.g., one or two dimensional arrays) to mirror a pattern for a grouping (e.g., an array) of the optical couplers 165 on the chip's surface 135.

In some embodiments, coupling to multi-cores may be simpler and more efficient (e.g., given a higher transmission capacity) than coupling to multimode cores. In some embodiments the use of multimode, and/or multicore optical fibers can provide an advantage in cases where the inter-chip communication (between the electronic chip and optical chip) has a short optical reach thereby making optical mode mixing small enough, between different optical cores or different optical modes of the same optical fiber, so that there is no need for multiple-input-multiple-output (MIMO) processing as familiar to one skilled in the art. This, in turn, could reduce the complexity of the optical receivers/transmitter devices.

In some embodiments, the core or cores can be each be constructed to have a large enough diameter (e.g., larger than the single mode limit) to improve alignment tolerance to thereby support multiple modes (e.g., two or three modes).

In some embodiments, the fibers can be configured with quadratic index profiles which have multiple modes but with sufficiently short and well controlled short optical reach, they can effectively image on the optical couplers 165.

In some embodiments, the holes 105 can be configured to enable rotation of the ends of the optical fibers 110 around axes (e.g., axis 178) of the corresponding end segments 106.

As illustrated in FIGS. 1A-2, in some embodiments, the alignment structure 145 can be one of an opening 180 (FIG. 1A-1B) or a protrusion 182 (FIG. 2) and the corresponding alignment structure 150 can be the other of the protrusion or the opening. For instance, the protrusion can be configured as a pin or other raised structure and the opening can be configured to fit at least a portion of the protrusion (e.g., pin or post) therein. As illustrated in FIG. 2, in some embodiments the protrusion 182 can further include a mechanical stop structure 220 that is configured to not fit in the opening 180 and thereby facilitate the vertical alignment between the ends 107 of the fibers 110 and the optical couplers 165, e.g., to not be in physical contact, and also prevent potential damage to the chip or the fibers by keeping the module 102 held above the surface 135 of the chip 140.

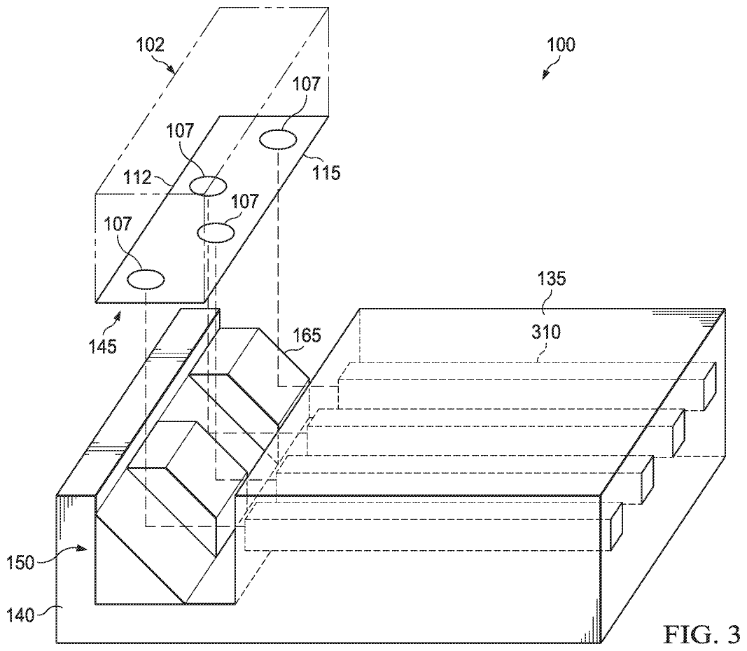

FIG. 3 presents a perspective view of another embodiment of the apparatus 100 of the disclosure. For clarity, only a detailed portion of the lower portions and bottom side 115 of the module 102 are depicted. Based on the present disclosure one skill in the art would understand how the components of the electrical monitoring circuit 170 such as described in the context of FIG. 1A-1B could be integrated in the module 102 shown in FIG. 3.

As illustrated, in some embodiments, the alignment structure 145 can be a side 115 (e.g., bottom side) of the module 102 and the corresponding alignment structure 150 can be a socket configured to fit at least a portion of the side 115 therein.

As illustrated, and for any of the embodiments of the apparatus 100, the fibers 110 may not, e.g., have physical contact with waveguides 310 located on or in the chip 140.

As illustrated, some embodiments of the optical couplers 165 can be or include tilted reflexive structures (e.g., 45 degree turning mirrors). In other embodiments, the optical couplers 165 can be or include vertical optical grating couplers. Based on the present disclosure, one skilled in the art would understand how other types of vertical or lateral optical couplers could be used as the optical couplers.

In some embodiments, the apparatus 100 can be part of a multi-chip device package.

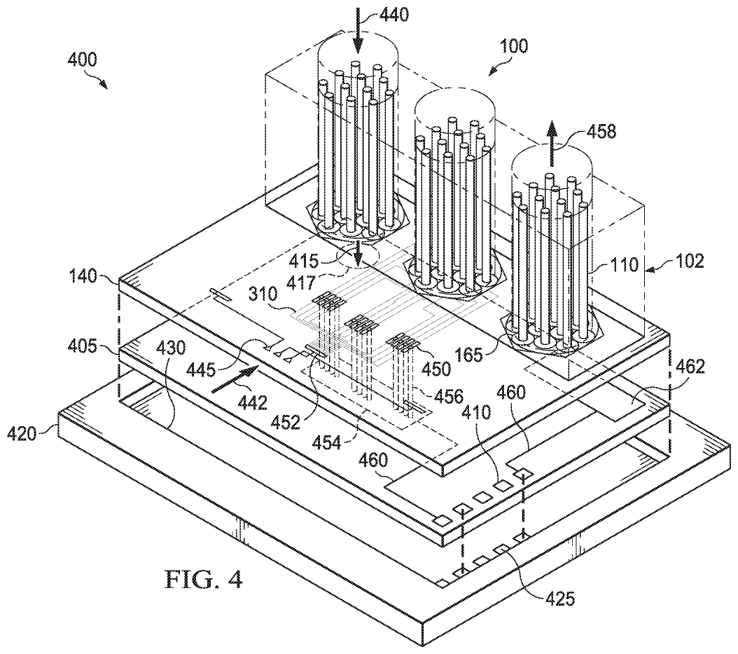

FIG. 4 presents an exploded perspective view of portions of a multi-chip device package 400 of the apparatus 100.

As illustrated the package 400 includes an electrical chip 405 (e.g., including a digital data processor and, e.g., configured as an ASIC, CPU, GPU, FPGA, network switch chip) having solderless electrical connections 410. The package also includes an integrated optical device 140 (e.g., configured as an opto-electronic chip, photonic integrated circuit chip) having optical connections 415 to the electrical chip 405 (e.g., to a photodetector module 417 of the chip 405). The solderless electrical connections 410 are configured to support low speed control signal or power supply connections to the electrical chip 405 and the optical connections 415 are configured to support high speed data communications to the electrical chip 405.

As illustrated, the integrated optical device 140 can be stacked on top of the electrical chip 405 and the electrical chip 405 can be fitted into a socket module 420 having corresponding solderless electrical connections 425 configured to contact the solderless electrical connections 410 of the electrical chip 405. For instance, the socket module 420 can include one or more sockets 430 configured to fit at least a portion of the electrical chip 405 therein such that each of the solderless electrical connections 410 of the electrical chip 405 contact the corresponding ones of the solderless electrical connections 425 of the socket module 420 and such that the electrical chip 405 (and stacked on optical chip 405) can be removed from the socket 430 with no solder reflow. As a non-limiting example, the solderless electrical connections 410, 425 can be configured as pins, posts, pads, balls, slots, clips or combinations thereof or other configurations familiar to those skilled in the art for incorporation in an about zero-insertion force (ZIF) socket 430, a zero-land grid array (LGA) socket 430 or a ball-grid array socket 430 of the socket module 420.

As illustrated, optical couplers 165 of the integrated optical device 140 can be configured to accept optical signals 440 (e.g., optical power signals) from vertically-oriented fibers 110. In some embodiments, the lateral and vertical orientation of the fibers 110 with the optical couplers 165 can be facilitated with the use of the apparatus 100 such as disclosed herein in the context of FIGS. 1-3.

In some embodiments, the integrated optical device 140 can alternatively or additionally be configured to accept (e.g., via input grating couplers 452, optical power signal 442 from laterally-oriented fibers and/or individual optical cores thereof.

Non-limiting examples of optical signals 440, 442 include continuous-wave (CW) signals or regular optical pulse trains. In some embodiments, the optical signals 440, 442 are coupled to the integrated optical device 140 via polarization-maintaining fibers (e.g., fibers 110) and the optical signals 440 can be polarization-controlled on-chip using an active polarization controller, as familiar to those skilled in the art.

As further illustrated, the integrated optical device 140 can include one or more arrays of optical modulators 450 (e.g., intensity and/or phase optical modulators). For instance, the integrated optical device 140 can include an array of vertical optical couplers 165 configured to allow coupling to single- or multi-core fibers. The vertical optical couplers 165 can be located in various areas of the chip different from the areas containing the optical modulators 450.

The integrated optical device 140 can further include an optical power splitter 452 to split the one or more of the optical signals 440, 442 among the optical modulators 450 for data modulation via drivers located in a driver module 454 of the electrical chip 405. Electrical contacts 456 (shown in exaggerated vertical scale) running to the top surface 457 of the electrical chip 405 directly contact the corresponding optical modulators 450 that are located vertically above to thereby provide a data modulation signal via drivers of the driver module 454. The resulting data-modulated optical signal 458 can be directed via waveguides 310 and the optical coupler 165 to one or more fibers 110 for transmission to one or more different device packages 400 or other optical device. Although the device package 400 has been described in use when configured as an optical data transmitter, one skilled in the art would appreciate how the package 400 could alternatively or additionally be configured as an optical data receiver or an optical data transceiver.

In some embodiments, to support high-speed optical data modulation, the electrical contacts 456 are soldered to the optical modulators 450, in which case reflow would be required to separate the electrical chip 405 from the integrated optical device 140. However, the pair of the electrical chip 405 and the integrated optical device 140 could be removed by removing the electrical chip 405 from the socket module 420 without solder reflow.

As illustrated, in some embodiments, the solderless electrical connections 410 can be configured to transmit via electrically conductive lines 460 on the chip's surface 457 electrical power to the data driver module 454 or low-speed electrical signals to or from a control module 462 of the electrical chip 405.

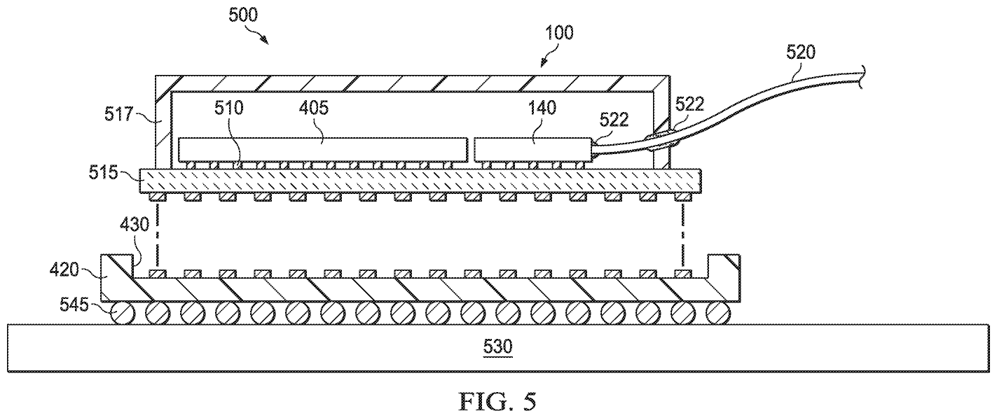

FIG. 5 presents a cross-sectional view of another multi-chip device package 500 embodiment of the disclosure. The electrical chip (405) configured as an ASIC can be co-packaged (e.g., bump bonded 510) on, e.g., a ceramic carrier (e.g., carrier 515, lid 517) with the optical chip (140) configured as a photonic interconnect chip. The ASIC can be configured as a data processor, e.g., as any of but not limited to be CPU, GPU, FPGA or network switch and have many high capacity data connections. Fiber connections (520) attached to photonic interconnect chip can be achieved by using low temperature technique e.g., adhesive (522). Embodiments of the package 500 can be a 2.5D package (e.g., having multiple chips inside the same package as familiar to those skilled in the art). The electrical connections can be used for DC power supply as well as low-speed 1<Gb/s or <5 Gb/s communications, and therefore do not require carefully controlled RF impedance performance for signaling. The chips can be mounted on a printed circuit board PCB (530) via a socket module (420) instead of soldering (e.g., pins, LGA, ZIF 430). The socket module can be soldered to the PCB (solder 545) but before the package 500 is inserted.

Package embodiments such as illustrated in FIGS. 4 and 5 advantageously need not be designed to withstand solder reflow temperatures (e.g., ˜260° C.) of bonding the socket module to the PCB.

Avoiding such high temperatures facilitates optical components (optical chip, fiber) to maintain performance and reliability, allows wider range of organic adhesives including optical adhesives to be used, and still allows a solder assembly to be used in the package, where the lower temperature solders may be used since the package does not to have to survive PCB solder reflow temperature.

Having electrical and optical chips that are more easily replaced facilitates low cost and efficient upgrading with new chips, replacing faulty or damaged chips or replacement of failed or faulty optical interconnects.

Those skilled in the art to which this application relates will appreciate that other and further additions, deletions, substitutions and modifications may be made to the described embodiments.

What is claimed is:

1. An apparatus, comprising:
an optical fiber connector module, the optical fiber connection module comprising: an array of holes there-through for holding end segments of the optical fiber therein such that the end of each of the optical fibers has a fixed distance relationship with an external surface of the module, the module having one or more electrical conductor lines therein with electrical contacts thereto along the external surface and having one or more first mechanical alignment structures along the external surface; and
an integrated optical device having one or more second mechanical alignment structures along an outer surface thereof, the first and second mechanical alignment structures capable of being fitted together such that the outer surface and external surface have a fixed relative positional relationship and such that the electrical contacts of the optical fiber connector module are adjacent to electrical contacts of the integrated optical device.

2. The apparatus of claim 1, further comprising an electrical monitoring circuit configured to monitor a relative distance between the surfaces based on one or more electrical signals applied to the contacts of the integrated optical device.

3. The apparatus of claim 1, wherein the integrated optical device has an array of vertical optical couplers along the outer surface.

4. The apparatus of claim 4, wherein the vertical optical couplers are located to face adjacent ends of the optical fibers in response to the first and second mechanical alignment structures capable of being fitted together such that the outer surface and external surface have the fixed relative positional relationship.

5. The apparatus of claim 1, further comprising the optical fibers, wherein the optical fibers being multi-core optical fibers.

6. The apparatus of claim 5, wherein the holes are configured to enable rotation of the ends of the optical fibers around axes of the corresponding end segments.

7. The apparatus of claim 1, wherein the mechanical alignment structure is one of an opening or protrusion and the corresponding alignment structure is the other of the protrusion or the opening.

8. The apparatus of claim 1, wherein the alignment structure is a side of the module and the corresponding alignment structure is a socket configured to fit at least a portion of the side therein.

9. The apparatus of claim 1, wherein the optical fiber connector module is part of a multi-chip device package having an optical chip and an electrical chip.

10. The apparatus of claim 1, further comprising:
a multi-chip device package, comprising the integrated optical device; and
an electronics chip having solderless electrical connections configured to have power supply connections and wherein the integrated optical device is configured to optically provide data communications with respect to the electrical chip.

11. The apparatus of claim 10, wherein the optical chip is stacked on the electronics chip and the electronics chip is fitted into a socket module having corresponding solderless electrical connections configured to contact the solderless electrical connections of the electronics chip.

12. The apparatus of claim 11, wherein the socket module includes a mechanical alignment socket configured to fit at least a portion of the electrical chip therein such that the solderless electrical connections of the electrical chip contact the corresponding solderless electrical connections of the socket module.

13. The apparatus of claim 11, wherein some of the solderless electrical connections are configured as a zero insertion force socket, zero land grid array socket or a ball grid array socket of the socket module.
